(19) United States
(12) Patent Application Publication
(10) Pub. No.: US 2026/0245305 A1
(43) Pub. Date: Aug. 20, 2026

(54) METHODS AND SYSTEMS FOR SCALABLE SKINNING OF THREE-DIMENSIONAL (3D) OBJECTS

(71) Applicant: GOOGLE LLC, Mountain View, CA (US)

(72) Inventors: Douglas Sim Dietrich, Jr., Los Gatos, CA (US); Stacey Rider Peterson, Santa Cruz, CA (US)

(21) Appl. No.: 19/164,554

(22) PCT Filed: Mar. 13, 2023
(86) PCT No.: PCT/US2023/015140

§ 371 Date: Sep. 11, 2025

(51) Int. Cl. G06T 17/20; G06T 13/40; G06T 15/04

(52) U.S. Cl. CPC G06T 17/20; G06T 13/40; G06T 15/04

(57) ABSTRACT

A method and system are disclosed for scalable skinning of three-dimensional (3D) objects. Data associated with a bone structure and a mesh for rendering a three-dimensional (3D) object is identified. The identified data includes, for each vertex of the mesh, an indication of a set of bones of the bone structure assigned to the vertex and a weight for each bone of the assigned set of bones. A determination is made that a number of bones included in a first set of bones assigned to a first vertex of the mesh satisfies a first bone number criterion. A first subset of bones and a second subset of bones is identified from the first set of bones. The weight of each of the first subset of bones satisfies a weight condition. A number of bones of the first subset of bones satisfies a second bone number criterion. Data associated with the first subset of bones is transmitted to a rendering engine as skinning data for rendering 3D objects. Data associated with the second subset of bones is transmitted to the rendering engine as one or more other types of data for rendering the 3D objects.

### TECHNICAL FIELD

Aspects and implementations of the present disclosure relate to scalable skinning of three-dimensional (3D) objects.

### BACKGROUND

Computer animation refers to the process of digitally generating animation. In an illustrative example, objects (models) are built on the computer monitor and 3D models are rigged with a virtual skeleton. The limbs, eyes, mouth, clothes, etc. of the object can be moved by the animator on key frames. The differences in appearance between key frames are automatically calculated by the computer and then the animation is rendered.

The 3D animated objects can be used by certain applications, such as video games in virtual reality (VR), applications in augmented reality (AR), avatars in certain programs, etc. to represent the objects to a user. In an example, a sports game played by a user in a virtual reality environment may require the generation of a virtual field, equipment, and players. In some applications, each object (e.g., each player) includes a polygon mesh (e.g., triangular mesh) having a set of vertices, i.e., points in space that form the polygon (e.g., triangle). The mesh can be applied to a bone structure (also referred to as a “skeleton”) of the object, which includes a hierarchy of connected bones that, when moved, deform the polygon mesh. Skinning refers to the process of assigning one or more bones of a bone structure for an object to a respective vertex of the polygon mesh.

### SUMMARY

The below summary is a simplified summary of the disclosure in order to provide a basic understanding of some aspects of the disclosure. This summary is not an extensive overview of the disclosure. It is intended neither to identify key or critical elements of the disclosure, nor delineate any scope of the particular implementations of the disclosure or any scope of the claims. Its sole purpose is to present some concepts of the disclosure in a simplified form as a prelude to the more detailed description that is presented later.

An aspect of the disclosure provides a computer-implemented method that includes identifying, by a processing device associated with a platform, data associated with a bone structure and a mesh for rendering a three-dimensional object. The identified data can include, for each vertex of the mesh, an indication of a set of bones of the bone structure assigned to the vertex and a weight for each bone of the assigned set of bones. The method further includes determining, by the processing device, that a number of bones included in a first set of bones assigned to a first vertex of the mesh satisfies a first bone number criterion. The method further includes identifying, by the processing device, a first subset of bones and a second subset of bones from the first set of bones. The weight of each of the first subset of bones satisfies a weight condition. A number of bones of the first subset of bones satisfies a second bone number criterion. The method further includes transmitting, by the processing device, data associated with the first subset of bones to a rendering engine via a first data channel and data associated with the second subset of bones to the rendering engine via the second data channel. The first data channel is associated with skinning data for rendering 3D objects. The second data channel is associated with one or more other types of data for rendering the 3D objects.

An aspect of the disclosure provides a system including a memory and a processor communicatively coupled to the memory. The processor performs operations including identifying data associated with a bone structure and a mesh for rendering a three-dimensional (3D) object. The identified data includes, for each vertex of the mesh, an indication of a set of bones of the bone structure assigned to the vertex and a weight for each bone of the assigned set of bones. The operations further include determining that a number of bones included in a first set of bones assigned to a first vertex of the mesh satisfies a first bone number criterion. The operations further include identifying, from the first set of bones, a first subset of bones and a second subset of bones. The weight of each of the first subset of bones satisfies a weight condition. A number of bones of the first subset of bones satisfies a second bone number criterion. The operations further include transmitting, to a rendering engine, data associated with the first subset of bones as skinning data for rendering 3D objects and the second subset of bones as one or more other types of data for rendering the 3D objects.

An aspect of the disclosure provides a system including a memory and a processor communicatively coupled to the memory. The processor performs operations including receiving first data associated with rendering a three-dimensional (3D) object via a first data channel and second data associated with rendering the 3D object via a second data channel. The first data channel is associated with skinning data for rendering 3D objects. The second data channel is associated with one or more other types of data for rendering 3D objects. The operations further include determining a first set of bones assigned to a vertex of a mesh associated with the 3D object based on the first data received via the first data channel. The operations further include determining a second set of bones of the bone structure assigned to the vertex of the mesh associated with the 3D object based on the second data received via the second data channel. The operations further include rendering at least the vertex of the mesh for the 3D object based on the determined first set of bones and the determined second set of bones.

An aspect of the disclosure provides a computer-implemented method that includes identifying, by a processing device associated with a platform, data associated with a bone structure and a mesh for rendering a three-dimensional (3D) object. The identified data includes, for each vertex of the mesh, an indication of a set of bones of the bone structure assigned to the vertex and a weight for each bone of the assigned set of bones. The method further includes determining, by the processing device, that a number of bones included in a first set of bones assigned to a first vertex of the mesh satisfies a first bone number criterion. The method further includes identifying, by the processing device and from the first set of bones, a first subset of bones and a second subset of bones. The weight of each of the first subset of bones satisfies a weight condition. The number of bones of the first subset of bones satisfies a second bone number criterion. The method further includes transmitting, to a rendering engine, data associated with the first subset of bones as skinning data for rendering 3D objects and the second subset of bones as one or more other types of data for rendering the 3D objects.

An aspect of the disclosure provides a computer program including instructions that, when the program is executed by a computer, cause the computer to carry out a method that includes identifying, by a processing device associated with a platform, data associated with a bone structure and a mesh for rendering a three-dimensional object. The identified data can include, for each vertex of the mesh, an indication of a set of bones of the bone structure assigned to the vertex and a weight for each bone of the assigned set of bones. The method further includes determining, by the processing device, that a number of bones included in a first set of bones assigned to a first vertex of the mesh satisfies a first bone number criterion. The method further includes identifying, by the processing device, a first subset of bones and a second subset of bones from the first set of bones. The weight of each of the first subset of bones satisfies a weight condition. A number of bones of the first subset of bones satisfies a second bone number criterion. The method further includes transmitting, by the processing device, data associated with the first subset of bones to a rendering engine via a first data channel and data associated with the second subset of bones to the rendering engine via the second data channel. The first data channel is associated with skinning data for rendering 3D objects. The second data channel is associated with one or more other types of data for rendering the 3D objects.

An aspect of the disclosure provides a computer program including instructions that, when the program is executed by a computer, cause the computer to carry out a method that includes identifying, by a processing device associated with a platform, data associated with a bone structure and a mesh for rendering a three-dimensional (3D) object. The identified data includes, for each vertex of the mesh, an indication of a set of bones of the bone structure assigned to the vertex and a weight for each bone of the assigned set of bones. The method further includes determining, by the processing device, that a number of bones included in a first set of bones assigned to a first vertex of the mesh satisfies a first bone number criterion. The method further includes identifying, by the processing device and from the first set of bones, a first subset of bones and a second subset of bones. The weight of each of the first subset of bones satisfies a weight condition. The number of bones of the first subset of bones satisfies a second bone number criterion. The method further includes transmitting, to a rendering engine, data associated with the first subset of bones as skinning data for rendering 3D objects and the second subset of bones as one or more other types of data for rendering the 3D objects.

### BRIEF DESCRIPTION OF THE DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIG. 1 illustrates an example system architecture, in accordance with implementations of the present disclosure.

FIG. 2 illustrates an example user management engine, and example model engine, and an example rendering engine, in accordance with some aspects of the present disclosure.

FIG. 3 illustrates an example rendering data component and example model files, in accordance with some aspects of the present disclosure.

FIG. 4 illustrates a flow diagram for an example method for providing data for rending a three-dimensional (3D) object to a rendering engine, in accordance with some aspects of the present disclosure.

FIG. 5 illustrates a flow diagram for an example method rendering a 3D object, in accordance with some aspects of the present disclosure.

FIG. 6 is a block diagram illustrating an exemplary computer system, in accordance with implementations of the present disclosure.

### DETAILED DESCRIPTION

Aspects of the present disclosure are directed to scalable skinning of three-dimensional (3D) objects. Skeletal rigging is a technique in animation in which a 3D object (e.g., a character, an animal, a building, a vehicle, etc.) is represented in two parts. The first part includes a surface representation of the object, referred to as a polygon mesh, a mesh, or skin. The second part includes a hierarchical set of interconnected parts. The entirety of the hierarchical set is referred to as a skeleton structure, a skeleton, or a rig, while each part of the hierarchical set is referred to as a bone. The polygon mesh can include a collection of vertices, edges, and faces that define a shape of a polyhedral object. Specifically, the polygon mesh can include a set of polygons composed to make up the surface for the object. For example, data representing the object can include an indication of a triangular mesh having a set of vertices that form triangles (and/or other attributes such as normals, color, or UV coordinates associated with corresponding texture images). The bones collectively form the skeleton or the rig, which is used as a virtual framework to animate the vertices of the polygons. The animation can be composed of key frames and in-between frames. The key frames represent markers or anchor points that define the start and end points for an action by the object. For example, the key frames can represent significant poses of a character's actions, such as the first and last positions of a jumping motion. In-between frames represent the poses between the key frames. That is, the in-between frames move the animation from one key frame to another. Other techniques for computer animation include Blendshape animation, morph target animation, etc.

Skinning refers to a process of assigning or associating one or more bones of a skeleton structure for a 3D object to a respective vertex of the polygon mesh for the 3D object. In some instances, skinning can be performed by an artist of the 3D object. Each bone assigned to a respective vertex can be assigned a bone weight (e.g., by the artist) that indicates a level of influence that the bone has on the vertex. For example, the movement of a bone having a larger weight for a vertex will have a greater influence on that vertex than a bone having a smaller weight for that vertex. In some instances, the assigned bone weights can have a value between approximately 0.0 and approximately 1.0, where a weight of 0.0 indicates a lowest influence level and 1.0 indicates a highest influence level. For example, a bone with a weight of 0.0 has no influence on an assigned vertex while a bone with a weight of 1.0 has complete influence (e.g., 100% influence) on the assigned vertex. Multiple bones can be assigned to a vertex, in some instances. When there are more than one bone assigned to a vertex, the weights of each assigned bone can add up to a value of approximately 1.0.

Each bone that is assigned to a respective vertex of a polygon mesh corresponds to additional data for rendering the 3D object. Accordingly, the more bones that are assigned to a respective vertex, the larger the data for rendering the 3D object, which can consume a significant amount of computing resources (e.g., memory space, processing cycles, power resources, network bandwidth, etc.) of the computer animation system. In some instances, it is important to render and animate objects quickly, preferably in real time or near real time. For example, in applications that at least partly operate as a cloud based or other over-network system, any limitations in network bandwidth or transmission speed available for transmission of the data for rendering and animating the 3D object might lead to unwanted lag. Furthermore, having to store and process large quantities of data for rendering and/or animating the 3D objects might lead to undesirably large data storage requirements, and may potentially lead to latency in processing, particularly for devices that have limited data storage or processing on board. In view of this, some computer animation systems are enabled to only support 3D objects having a threshold number of bones per vertex of the polygon mesh and are not enabled to support 3D objects having a number of bones per vertex that exceeds the threshold number of bones. For example, some systems are enabled to support rendering of 3D objects having a threshold of four bones per vertex of the polygon mesh and are not enabled to support rendering of 3D objects having more than four bones per vertex. However, rendered objects having a higher number of bones per vertex have a higher quality (e.g., can have fewer rendering errors, can appear to be more visually realistic, etc.) than rendered objects having a fewer number of bones per vertex. Accordingly, computer animation systems that only support a threshold number of bones per object (e.g., four bones per object) can render low quality images of 3D objects. In order to render a high quality image of a 3D object, some computer animation systems have enabled rendering of 3D objects having larger numbers of bones per vertex. For example, some computer animation systems have enabled rendering of 3D objects having eight bones per vertex, 16 bones per vertex, 32 bones per vertex, etc. For example, this might be preferable for systems that have a high level computing resource such as processing and data storage capacity, network bandwidth, etc.

An artist or designer of a 3D object may not be aware of a computer animation system that will render the 3D object when the skinning process is performed (e.g., when the bones are assigned to vertices of the 3D object). Accordingly, the artist or designer may not be aware of the rendering constraints (e.g., a threshold number of bones per vertex) associated with the computer animation system that will render the 3D object. An option would be to create multiple data sets (e.g., model files) associated with the 3D object during or based on the skinning process for the 3D object, where each data set indicates a different number of bones per vertex that can be supported by computer animation systems with different rendering constraints. Skinning a 3D object can be a time intensive and resource intensive (e.g., memory intensive, processor intensive, etc.) process which can become more time intensive and/or resource intensive as a larger number of bones area assigned to a respective vertex. Accordingly, creating multiple data sets associated with a 3D object to comply with constraints of different computer animation systems can consume a large number of resources (e.g., processing cycles, memory space, network resource, etc.) of a computer system associated with the artist or designer of the 3D object and/or the computer animation system. The consumption of the large number of resources can reduce an overall efficiency of the computer system and/or the computer animation system and increase an overall latency of the computer system and/or the computer animation system. Further, as a 3D object may be rendered using a single computer animation system associated with particular rendering constraints, data sets generated to address other rendering constraints may not be used by the computer animation system. Generating and storing such data sets can consume a larger amount of memory space and processing cycles of the computer system associated with the artist or designer and/or the computer animation system, which can further reduce the overall efficiency of the computer system and/or the computer animation system and further increase the overall latency of the computer system and/or the computer animation system.

Implementations of the present disclosure address the above and other deficiencies by providing techniques for scalable skinning of three-dimensional (3D) objects. In some embodiments, a computing system (e.g., a platform, a computer animation system, etc.) can identify data associated with a bone structure and a mesh (e.g., a polygon mesh) for rendering a 3D object. The identified data can include, for each vertex of the mesh, an indication of a set of bones of the bone structure assigned to the vertex and a weight for each bone of the assigned set of bones. In some embodiments, the data can be identified based on rendering data provided to a platform (e.g., a content sharing platform) and/or a computer animation system by a computing device associated with an artist or developer of the 3D object.

In some embodiments, the computing system that identifies the data can determine that a number of bones included in the first set of bones assigned to a first vertex of the mesh satisfies a first bone number criterion. The bone number criterion may require, for example, that the number of bones included in the first set of bones exceed a threshold number of bones that can correspond to a standard number of bones assigned to vertices of meshes for 3D objects according to a rendering protocol associated with one or more rendering engines. In an illustrative example, the threshold number of bones can be approximately four bones per vertex, in accordance with rendering constraints of a rendering protocol for some rendering engines. The number of bones of the first set of bones can be larger than four (e.g., can be eight, 16, 32, etc.), which exceeds the threshold number of bones.

Responsive to determining that the number of bones of the first set of bones satisfies the first bone number criterion, the computing system can identify, from the first set of bones, a first subset of bones and a second subset of bones. Each of the first sub set of bones can satisfy a weight condition (e.g., can have a higher weight than each of the second subset of bones), in some embodiments. In additional or alternative embodiments, the number of bones of the first subset of bones can satisfy a second bone number criterion. The second bone criterion may require, for example, that the number of bones of the first subset of bones meet the threshold number of bones. For example, if the threshold number of bones per vertex is approximately four bones per vertex, the first subset of bones can include four bones of the first set of bones. The second subset of bones can include the remaining bones of the first set of bones. For instance, if the first set of bones includes eight bones and the first subset of bones includes four bones, the second subset of bones can include four bones. Each of the four bones of the first subset of bones can have a higher weight than bones of the second subset of bones, in some embodiments. For example, the bones of the first subset of bones may be the threshold number of bones of the first set with the highest weights.

In some embodiments, the computing system can modify a weight associated with each of the first set of bones to have a normalized value in view of a number of bones included in the first subset of bones. In an illustrative example, the weights associated with each of the first set of bones can be [0.2, 0.2, 0.2, 0.2, 0.1, 0.05, 0.02, 0], respectively, where each weight indicates a level of influence that a respective bone has on an assigned vertex. The sum of each weight for the first set of bones is approximately 1.0. The computing system can identify the bones having weights [0.2, 0.2, 0.2, 0.2] as the first subset of bones and the bones having weights [0.1, 0.05, 0.02, 0] as the second subset of bones (e.g., as each of the first subset of bones have higher weights than the second subset of bones). The computing system can modify or update the weights of each of the first subset of bones such that each weight is a normalized value in view of the number of bones in the first subset of bones. For example, the updated weights of the first subset of bones can be [0.25, 0.25, 0.25, 0.25], in some embodiments.

In additional or alternative embodiments, the computing system can convert data associated with the second subset of bones to another type of data (e.g., other than skinning data) associated with rendering the 3D object. In some embodiments, the computing system can convert a bone index and a weight with the second subset of bones to one or more texturing coordinates (e.g., UV coordinates, etc.). In an illustrative example, a bone index associated with a first bone of the second subset of bones can be “3” and a weight associated with the first bone of the second subset of bones can be “0.1”. The computing system can convert the data associated with the first bone to a texturing coordinate by associating the bone index (e.g., “3”) for the first bone with a first value of the texturing coordinate and the weight (e.g., “0.1” of the first bone with a second value of the texturing coordinate. The converted texturing coordinate can be “3.1,” according to the above described example. The computing system can convert the bone index and the weight for the other bones of the second subset of bones into texturing coordinates, as described above.

The computing system can transmit data associated with the first subset of bones to a rendering engine via a first data channel and data associated with the second subset of bones to the rendering engine via a second data channel, in some embodiments. A data channel refers to a data path used to transfer particular types of information from one system to another. A data channel, as described herein, can include a hardware data channel or a software data channel. The first data channel can be associated with skinning data for rendering 3D objects, in some embodiments. In additional or alternative embodiments, the second data channel can be associated with one or more other types of data (e.g., texturing coordinates) for rendering the 3D objects. As described above, the bone index and the weight associated with each of the bones of the second subset of bones can be converted to texturing coordinates. In such embodiments, the data associated with the subset of bones transmitted via the second data channel can include the converted set of texturing coordinates. In some embodiments, the converted set of texturing coordinates can be included in a portion of a model file for the 3D object that is unused by other types of data.

The rendering engine can receive first data (e.g., the data associated with the first subset of bones) via the first data channel and second data (e.g., the data associated with the second subset of bones) via the second data channel, in some embodiments. In some embodiments, the rendering engine can be enabled to render 3D objects having a number of bones per vertex that is larger than the threshold number of bones. For example, the rendering engine can be enabled to render 3D objects having eight bones per vertex, 16 bones per vertex, 32 bones per vertex, etc., which is larger than the threshold number of four bones per vertex. Such rendering engine can determine weights associated with each bone assigned to a particular vertex of the mesh for a 3D object based on the received first data and second data. As described above, the bone index and the weights for each of the second subset of bones can be converted to texturing coordinates, which are received by the rendering engine via the second data channel. The rendering engine can determine the bone index and weights for each of the second subset of bones by converting the texturing coordinates received via the second data channel to the bone indices and weights. For example, a first texturing coordinate can have a value of “3.1.” The rendering engine can determine that a bone index associated with a bone having a bone index of “3” has a weight of approximately “0. 1” based on the first texturing coordinate. The rendering engine can convert the texturing coordinates received via the second data channel to bone indices and weights for each of the second subset of bones, as described above. In accordance with the previous illustrative example, the rendering engine can determine the weights for each of the second subset of bones to have weights of [0.1, 0.05, 0.02, 0].

As described above, the first data can indicate a normalized weight value associated with each bone of the first subset of bones. The rendering engine can determine a true weight value (e.g., a non-normalized weight value) for each of the first subset of bones based on a total number of bones included in each of the first subset of bones and the second subset of bones. In accordance with the previously illustrative examples, the rendering engine can determine that the second subset of bones has four bones (e.g., based on the number of texturing coordinates received via the second data channel). The first data received by the rendering engine can indicate four additional bones. Accordingly, the rendering engine can determine that eight bones are assigned to the particular vertex. The rendering engine can determine the true weight value for each bone of the first subset of bones based on the number of bones (e.g., eight) of the first subset of bones and the second subset of bones. For example, the rendering engine can determine that the first subset of bones, having normalized weights of [0.25, 0.25, 0.25, 0.25] have true weights (or non-normalized weight) of [0.2, 0.2, 0.2, 0.2] based on the total number of bones assigned to the particular vertex. Accordingly, the rendering engine can determine that the weights for each bone assigned to the particular vertex are [0.2, 0.2, 0.2, 0.2, 0.1, 0.05, 0.02, 0].

The rendering engine can render at least the vertex of the mesh based on the determined first sub-set of bones and the determined second sub-set of bones, in some embodiments. In some embodiments, the rendering engine can render the vertex based on the weights determined for the first sub-set of bones and the second sub-set of bones (e.g., [0.2, 0.2, 0.2, 0.2, 0.1, 0.05, 0.02, 0]), as described above.

In some embodiments, the rendering engine that receives the first data and second data from the computing system is not enabled to render 3D objects having a number of bones per vertex that is larger than the threshold number of bones. For example, the rendering engine can be enabled to render 3D objects having four bones per vertex and cannot render 3D objects having more than four bones per vertex. Such rendering engines can render the vertex for the 3D object described above based on the data received via the first data channel, in some embodiments. In such embodiments, the rendering engine can disregard the second data received via the second data channel.

Accordingly, aspects of the present disclosure provide techniques for enabling rendering engines having different rendering constraints to render 3D objects based on the same data (e.g., model file) for the 3D objects. Embodiments of the present disclosure enable an artist or developer associated with a 3D object to assign any number of bones to a respective vertex of a mesh for the 3D object. The computing system can convert data associated with each bone assignment to data that can be processed by rendering engines having different rendering constraints. For example, a rendering engine enabled to render objects having a larger number of bones per vertex can render the 3D object based on the same data (e.g., model file) that is used by a rendering engine enabled to render objects having a smaller number of bones. Accordingly, a single set of rendering data (e.g., a single model file) can be generated for the 3D object, rather than multiple sets of rendering data (e.g., multiple model files). By generating a single set of rendering data rather than multiple sets of rendering data, a fewer amount of computing resources (e.g., memory, processing cycles, etc.) are consumed by a computing system that generates and/or uses the rendering data which can improve an overall efficiency and decrease an overall latency of such computing system. Furthermore, the rendering process can be made easier to use, as a single set of rendering data (e.g., a single model file) can be used rather than having to select a set of rendering data corresponding to a threshold number of bones used by a particular rendering engine.

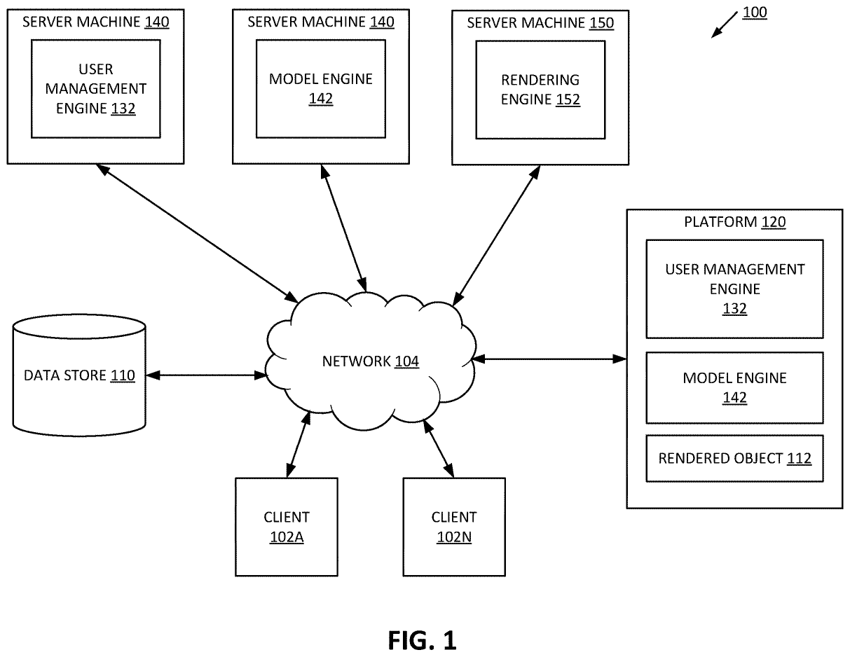

FIG. 1 illustrates an example system architecture 100, in accordance with implementations of the present disclosure. The system architecture 100 (also referred to as “system” herein) includes client devices 102A-N, a data store 110, a platform 120 (e.g., a content sharing platform), and/or one or more server machines 130-150, each connected to a network 104. In implementations, network 104 may include a public network (e.g., the Internet), a private network (e.g., a local area network (LAN) or wide area network (WAN)), a wired network (e.g., Ethernet network), a wireless network (e.g., an 802.11 network or a Wi-Fi network), a cellular network (e.g., a Long Term Evolution (LTE) network), routers, hubs, switches, server computers, and/or a combination thereof.

The client devices 102A-N (collectively and individually referred to as client device(s) 102 herein) may each include computing devices such as personal computers (PCs), laptops, mobile phones, smart phones, tablet computers, netbook computers, network-connected televisions, etc. In some implementations, client devices 102A-N may also be referred to as “user devices.” Each client device may include a content viewer. In some implementations, a content viewer may be an application that provides a user interface (UI) for users to view or upload content, such as images, video items, web pages, documents, etc. For example, the content viewer may be a web browser that can access, retrieve, present, and/or navigate content (e.g., web pages such as Hyper Text Markup Language (HTML) pages, digital media items, etc.) served by a web server. The content viewer may render, display, and/or present the content to a user. The content viewer may also include an embedded media player (e.g., a Flash® player or an HTML5 player) that is embedded in a web page (e.g., a web page that may provide information about a product sold by an online merchant). In another example, the content viewer may be a standalone application (e.g., a mobile application or app) that allows users to view digital media items (e.g., digital video items, digital images, electronic books, etc.).

In some embodiments, platform 120 can provide one or more client devices 102 with access to an application (not shown) associated with 3D objects. The application can provide one or more 3D objects (e.g., virtual avatars) for display via a UI of client device(s) 102. Data store 110 can store data associated with rendering the object, in some embodiments. In some implementations, data store 110 is a persistent storage that is capable of storing data as well as data structures to tag, organize, and index the data. Data store 110 may be hosted by one or more storage devices, such as main memory, magnetic or optical storage based disks, tapes or hard drives, NAS, SAN, and so forth. In some implementations, data store 110 may be a network-attached file server, while in other embodiments data store 110 may be some other type of persistent storage such as an object-oriented database, a relational database, and so forth, that may be hosted by platform 120 or one or more different machines coupled to platform 120 via network 104.

In some embodiments, the 3D objects provided by the application can be or correspond to virtual avatars associated with one or more users of platform 120. A virtual avatar refers to a virtual character or representation associated with a user. The user can control the virtual avatar (e.g., via an associated client device 102) and/or can interact with virtual avatars associated with other users via the application. In some embodiments, the virtual avatar associated with the user can be generated based on image data (e.g., photos, video data, etc.) provided to platform 120 (e.g., by the user) and can depict one or more characteristics of the user. In other or similar embodiments, the virtual avatar can depict one or more characteristics of a character selected by the user. It should be noted that embodiments of the present disclosure apply to any type of virtual avatar and/or any type of 3D object.

Platform 120 can include a user management engine 132 and/or a model engine 142, in some embodiments. In additional or alternative embodiments, user management engine 132 can reside at server machine 130 and model engine 142 can reside at server machine 140. Platform 120 can access user management engine 132 and/or model engine 142 via network 104, in such embodiments. System 100 can additionally or alternatively include rendering engine 152. Rendering engine 152 can reside at server machine 150, in some embodiments, or at platform 120, in additional or alternative embodiments.

User management engine 132 can be configured to manage data associated with one or more users of platform 120. In some embodiments, user management engine 132 can obtain data associated with a virtual avatar associated with the user (e.g., from client device 102) and can store the obtained data at data store 110. The obtained data can include image data associated with the user, one or more avatar characteristics associated with the virtual avatar (e.g., clothing style, hair style, hair color, accessories), and so forth. Model engine 142 can be configured to generate object data associated with the virtual avatar for the user. The object data can include data used by rendering engine 152 to render the virtual avatar, in some embodiments. In some embodiments, the object data can be included in a model file that is used by rendering engine 152 to render the virtual avatar.

Object data associated with the virtual avatar (or any other type of 3D object) can include an indication of a bone structure for the virtual avatar and/or an indication of a mesh (e.g., a polygon mesh) for the virtual avatar. The bone structure can include one or more bones that are each indicated by a bone index. The mesh can include one or more polygons made up of vertices, edges, and faces. In some embodiments, the object data can additionally or alternatively include an indication of an assignment of a set of bones to a particular vertex of the mesh. An assignment of a set of bones to a particular vertex can include a mapping between a bone index for each bone of the set of bone to a vertex index associated with the particular vertex. In some embodiments, object data can additionally or alternatively include an indication of a weight associated with each bone assigned to the particular vertex. A bone weight (simply referred to as a weight here) can indicate a level of influence that a respective bone has on an assigned vertex. In some embodiments, the number of bones in the set of bones assigned to a particular vertex can meet a threshold number of bones, representing a standard number of bones according to rendering constraints for one or more rendering engines. In other or similar embodiments, the number of bones in the set of bones can exceed the threshold number of bones. In an illustrative example, the threshold number of bones can be four bones per vertex, according to rendering constraints for one or more rendering engines. In some embodiments, the object data for a 3D object can be provided by a client device 102 associated with an artist or developer of the 3D object. In other or similar embodiments, the object data can be determined or otherwise generated by model engine 142 (e.g., based on a model template provided by an artist or developer of the 3D object and/or a developer of platform 120).

As indicated above, in some embodiments, a number of bones assigned to a vertex of a mesh for a 3D object can exceed a threshold number of bones, in some embodiments. In such embodiments, model engine 142 can update data associated with the bones assigned to the vertex to include first data and second data. The first data can include data associated with a first set of bones that satisfies the threshold number of bones and the second can include data for the second set of bones that is converted to other data associated with rendering the 3D object. In some embodiments, data for the second set of bones is converted to one or more texturing coordinates. Model engine 142 can provide the first data and the second data to the rendering engine 152 via distinct data channels, in some embodiments. For example, model engine 142 can transmit the first data to rendering engine 152 via a first data channel associated with skinning data for 3D objects and the second data to rendering engine 152 via a second data channel associated with other types of data (e.g., texturing data) for 3D objects. Further details regarding updating the data associated with the bones assigned to the vertex and transmitting the updated data is described herein.

Rendering engine 152 can be configured to render a 3D object (e.g., a virtual object). As indicated above, rendering engine 152 can be a part of platform 120 or can be separate from platform 120, in some embodiments. In some embodiments, rendering engine 152 can render the 3D object based on data obtained from model engine 142 via one or more data channels. In some embodiments, rendering engine 152 can be enabled to render a 3D object having a number of bones per vertex that exceeds the threshold number of bones. In some embodiments, rendering engine 152 can render the 3D object based on data received via a first data channel (e.g., associated with skinning data for the 3D object) and a second data channel (e.g., associated with other data for the 3D object). In other or similar embodiments, rendering engine 152 can be enabled to render the 3D object having a number of bones per vertex that meets the threshold number of bones. In such embodiments, rendering engine 152 can render the 3D object based on the data received via the first data channel. Rendering engine 152 can disregard and/or ignore data received via the second data channel, in some embodiments. In some embodiments, rendering engine 152 can provide the rendered object 112 to platform 120 (e.g., via network 104). Platform 120 can provide the rendered object 112 to a user associated with client device 102 via a UI of the application at client device 102, as described above. Further details about rendering engine 152 and providing the rendered object 112 to client device 102 are described herein.

In some implementations, platform 120 and/or server machines 130-150 may operate on one or more computing devices (such as a rackmount server, a router computer, a server computer, a personal computer, a mainframe computer, a laptop computer, a tablet computer, a desktop computer, etc.), data stores (e.g., hard disks, memories, databases), networks, software components, and/or hardware components. In some implementations, the functions of platform 120 and/or server machines 130-150 may be provided by a more than one machine. For example, in some implementations, the functions of user management engine 132, model engine 142, and/or rendering engine 152 may be provided by two or more separate server machines. Platform 120, and/or server machines 130-150 may also include a website (e.g., a webpage) or application back-end software that may be used to enable a user to access media items, as described herein.

In general, functions described in implementations as being performed by platform 120 can also be performed on the client devices 102 in other implementations, if appropriate. In addition, the functionality attributed to a particular component can be performed by different or multiple components operating together. Platform 120 can also be accessed as a service provided to other systems or devices through appropriate application programming interfaces, and thus is not limited to use in websites.

It should be noted that although some embodiments of the present disclosure are directed to a content sharing platform, embodiments of this disclosure can be applied to other types of platforms. For example, embodiments of the present disclosure can be applied to a content archive platform, a content storage platform, etc.

In implementations of the disclosure, a “user” can be represented as a single individual. However, other implementations of the disclosure encompass a “user” being an entity controlled by a set of users and/or an automated source. For example, a set of individual users federated as a community in a social network can be considered a “user.” In another example, an automated consumer can be an automated ingestion pipeline, such as a topic channel, of the platform 120.

In situations in which the systems discussed here collect personal information about users, or can make use of personal information, the users can be provided with an opportunity to control whether platform 120 collects user information (e.g., information about a user's social network, social actions or activities, profession, a user's preferences, or a user's current location), or to control whether and/or how to receive content from the content server that can be more relevant to the user. In addition, certain data can be treated in one or more ways before it is stored or used, so that personally identifiable information is removed. For example, a user's identity can be treated so that no personally identifiable information can be determined for the user, or a user's geographic location can be generalized where location information is obtained (such as to a city, ZIP code, or state level), so that a particular location of a user cannot be determined. Thus, the user can have control over how information is collected about the user and used by the platform 120.

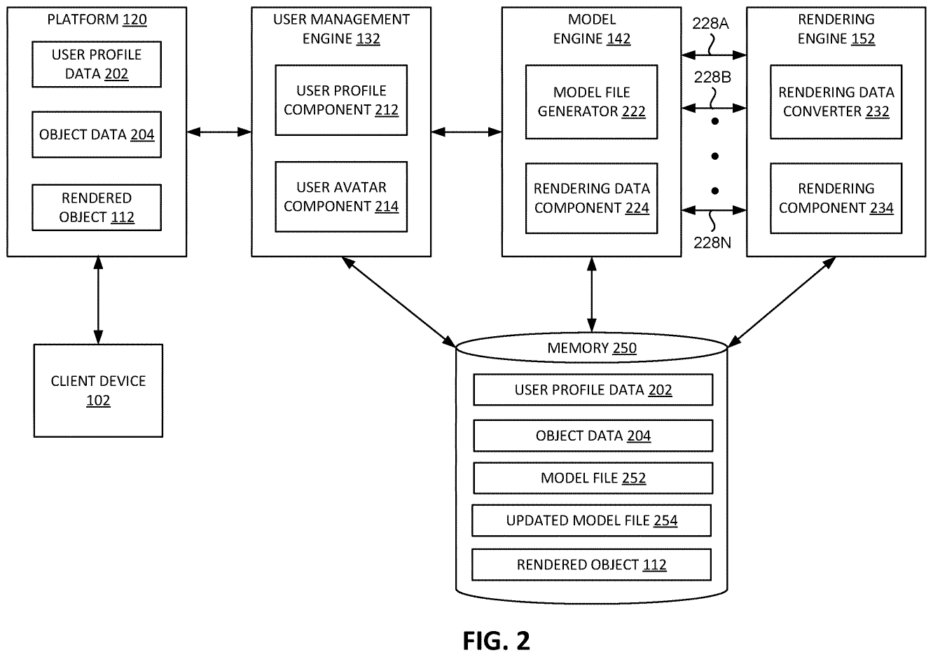

FIG. 2 illustrates an example user management engine 132, and example model engine 142, and an example rendering engine 152, in accordance with some aspects of the present disclosure. In some embodiments, user management engine 132, model engine 142, and/or rendering engine 152 can reside at or can otherwise be connected to platform 120 (e.g., via network 104). User management engine 132, model engine 142, and/or rendering engine 152 can be connected to memory 250, in some embodiments. Memory 250 can correspond to one or more portions of data store 110, in some embodiments. In additional or alternative embodiments, memory 250 can correspond to any memory of, connected to, or accessible by a component of system 100.

As described above, an 3D object rendered by rendering engine 152 can, in some embodiments, include a virtual avatar associated with a user of platform 120. The virtual avatar can be rendered to include one or more characteristics, as provided by the user of platform 120. The one or more characteristics can be included with or otherwise indicated by user profile data 202, in some embodiments. User profile data 202 can include data associated with a user that is provided by or otherwise received by a client device 102 associated with the user. In some embodiments, the virtual avatar can be rendered to include one or more characteristics that are the same or similar to characteristics of the user (e.g., hair color, eye color, etc.). In such embodiments, the user profile data 202 can include an indication of one or more characteristics of the user, as provided via client device 102. The indication of the one or more characteristics of the user can include image data for an image depicting the user, or other data that indicates the characteristics of the user, in some embodiments. In other or similar embodiments, the virtual avatar can be rendered as a character or object based on characteristics provided by the user. In such embodiments, user profile data 202 can include an indication of the characteristics of the character or object, as provided via client device 102.

As illustrated in FIG. 2, user management engine 132 can include user profile component 212 and user avatar component 214. User profile component 212 of user management engine 132 can obtain the user profile data 202 from platform 120 and, in some embodiments, can store the user profile data 202 at memory 250. In some embodiments, user profile component 212 can store a mapping between the obtained user profile data 202 and an identifier associated with a profile of the user and/or the client device 102 associated with the user at memory 250.

In some embodiments, an artist or developer of a 3D object, such as the virtual avatar, can provide object data 204 associated with the 3D object to platform 120 (e.g., via a client device associated with the artist or developer). The object data 204 can include rendering data for default characteristics for the 3D object, as defined by the artist or the developer. For example, the object data 204 can include an indication of a bone structure and a mesh (e. g, a polygon mesh) for the 3D object, an indication of an assignment of one or more bones of the bone structure to a vertex of the mesh, and/or an indication of one or more default characteristics (e.g., indicated by default texturing coordinates, color data, etc.) for rendering the 3D object. In some embodiments, platform 120 can store the object data 204 at memory 250. User avatar component 214 of user management engine 132 can update object data 204 to include a mapping between one or more characteristics of the virtual avatar associated with the user of platform 120 to corresponding data of object data 204. For example, user avatar component 214 can update object data 204 to include a mapping between one or more texturing coordinates and/or color data associated with a portion of the virtual avatar including the avatar's eyes and an eye color of the user, as indicated by user profile component 212.

It should be noted that in other or similar embodiments, object data 204 and/or characteristics of a virtual avatar can be provided by another system other than platform 120. For example, a computing system other than platform 120 can provide a model file 252 for rendering the virtual avatar via rendering engine 152. The model file 252 can include object data 204 and/or characteristics of the virtual avatar, in some embodiments. In other or similar embodiments, model file generator 222 can generate or update the model file 252 based on the user profile data 202 and/or the object data 204 obtained from platform 120, as described above.

Model engine 142 can include a model file generator 222 and/or a rendering data component 224, as illustrated in FIG. 2. In some embodiments, model file generator 222 can generate a model file 252 for rendering a 3D object, such as a virtual avatar, based on object data 204. A model file 252 can include instructions that are executed by rendering engine 152 when rendering the 3D object. The instructions can include rendering instructions based on the object data 204 and/or one or more motions or movements that the 3D object can undergo, as provided by an application associated with the 3D object. A user of platform 120 can, in come embodiments, interact with one or more elements of a UI of client device 102 and/or one or more elements of a peripheral device of or connected to client device 102 to control the motions or movements of the 3D object, in some embodiments.

In some embodiments, model file generator 222 can obtain object data 204 from memory 250 and can generate model file 252 based on the object data 204. As indicated above, object data 204 can indicate an assignment of a set of bones of a bone skeleton of the 3D object and a particular vertex of the mesh of the 3D object. The number of bones of the set of bones can meet or exceed a threshold number of bones, in some embodiments. The threshold number of bones can correspond to the standard number of bones according to rendering constraints of one or more rendering engines (e.g., including or different from rendering engine 152), in some embodiments. In some embodiments, model file generator 222 may generate model file 252 based on object data 204 according to one or more model file protocols or model file formats.

Rendering data component 224 can update model file 252 to generate updated model file 254, which includes updated bone/vertex assignment data, in accordance with embodiments of the present disclosure. As described above, model file 252 can include, in view of object data 204, an indication of a set of bones assigned to each vertex of the mesh of the 3D object. The set of bones can, in some embodiments, have a number of bones that exceeds the threshold number of bones. Rendering data component 224 can update model file 252 to indicate a subset of the set of bones, where the subset includes a number of bones that corresponds to the threshold number of bones. The data for the remaining bones of the set of bones can be converted to one or more other types of data (e.g., texturing coordinates) in some embodiments. Further details regarding rendering data component 224 and updated model file 254 are provided below.

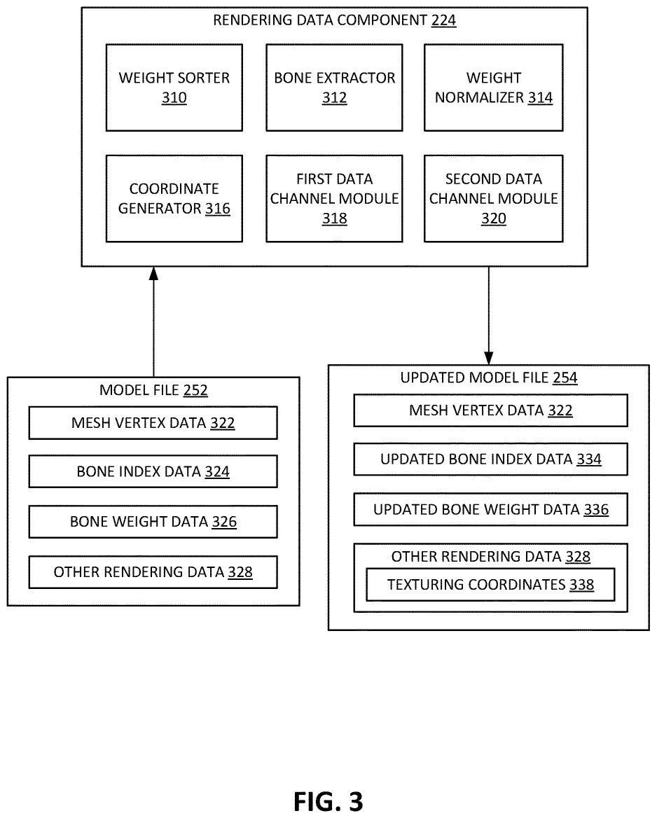

FIG. 3 illustrates an example rendering data component 224 and example model files, in accordance with some aspects of the present disclosure. As illustrated in FIG. 3, rendering data component 224 can include a weight sorter 310, a bone extractor 312, a weight normalizer 314, a coordinate generator 316, a first data channel module 318 and/or a second data channel module 320.

As described above, model file generator 222 can generate model file 252 based on object data 204. In some embodiments, the generated model file 252 can include mesh vertex data 322, bone index data 324, bone weight data 326, and/or other rendering data 328. Mesh vertex data 322 can include an identifier associated with a vertex of the mesh (e.g., the polygon mesh) for a 3D object. Bone index data 324 can include a bone index for each of a set of bones of the bone structure for the 3D object that is assigned to the vertex of the mesh. The bone index can include, in some embodiments, a unique identifier for a respective bone and/or an indication of a position of the bone in the hierarchy of the bone structure. Bone weight data 326 can indicate a weight for each bone of the set of bones assigned to the vertex. Other rendering data 328 can include other rendering data 328 (e.g., texturing coordinates, etc.) that is used by rendering engine 152 to render the 3D object, as described herein.

Weight sorter 310 can sort each bone of the set of bones based on the weight associated with each respective bone to obtain a bone ordering. In some embodiments, bones having a larger weight can be at the top of the bone ordering and bones having a smaller weight can be at the bottom of the bone ordering. In an illustrative example, bone index data 324 can indicate that the set of bones assigned to the vertex have bone indices of [0, 1, 2, 3, 4, 5, 6, 7], respectively. Bone weight data 326 can indicate that the weights for each of the set of bones is [0.1, 0.15, 0.2, 0.2,0.2, 0.2,0.05, 0], respectively. Weight sorter 310 can sort the set of bones based on the weights such that the bones having the larger weights are at the top of the bone ordering and the bones having the smaller weights are at the bottom of the bone ordering. In view of the above example, the ordered bone weights can be [0.2, 0.2, 0.2, 0.2, 0.15, 0.1, 0.05, 0] and the bone indices of the set of bones according to the bone ordering can therefore be [2, 3, 4, 5, 1, 0, 6, 7].

Bone extractor 312 can extract a subset of bones from the set of bones assigned to the vertex that satisfies one or more weight conditions. A number of bones of the subset of bones can correspond to the threshold number of bones, described above. In some embodiments, a bone can satisfy the weight condition(s) and be included in the extracted subset of bones if the weight for the bone is larger than other bones of the set of bones. In accordance with the previous illustrative example, the threshold number of bones can be approximately four bones per vertex and therefore the subset of bones can include four bones of the set of bones. Bones associated with bone indices [2, 3, 4, 5] are associated with larger weights than other bones of the subset of bones, and therefore bone extractor 312 includes such bones in the extracted subset of bones. It should be noted that the weight condition(s) can correspond to other criteria, in some embodiments. For example, if the threshold number of bones is four bones per vertex and five of the set of bones have an equal weight that is higher than other weights of the set of bones, bone extractor 312 can include four bones of the five bones that have the closest proximity to the vertex in the extracted subset of bones.

In additional or alternative embodiments, bone extractor 312 (or another component of rendering data component 224) can identify and/or extract the subset of bones using one or more machine learning model. For example, a machine learning model can be trained to determine, based on bone index data 324 and/or bone weight data 326 for a vertex of a mesh, one or more bones of a set of bones for the vertex that satisfy weight conditions and are to be included in the extracted set of bones. The machine learning model can be trained using historical bone index data and/or bone weight data associated with a mesh for a prior 3D object rendered by rendering engine 152 and/or another rendering engine. Bone extractor 312 (or another component of rendering data component 224) can provide bone index data 324 and/or bone weight data 326 as input to the machine learning model and can obtain one or more outputs from the machine learning model. The one or more outputs can indicate a bone index for bones that should be extracted from the set of bones, as described herein. Bone extractor 312 can extract the subset of bones having the indices indicated by the outputs of the machine learning model, in some embodiments.

Weight normalizer 314 can update the weight values associated with each of the subset of bones to a normalized value in view of a number of bones included in the subset of bones. A summation of each of the normalized values for the extracted subset of bones can have a value of approximately 1.0, in some embodiments. In accordance with the previous illustrative example, the extracted subset of bones can include four bones that each have a non-normalized weight of [0.2, 0.2, 0.2, 0.2], respectively. The summation of each of the non-normalized weight values for the subset of bones is approximately 0.8. Weight normalizer 314 can determine that the weights of each of the four bones in the subset of bones is equally distributed and can update the weights to be [0.25, 0.25, 0.25, 0.25]. The summation of each of the normalized weight values for the subset of bones can be approximately 1.0, in some embodiments.

Rendering data component 224 can update model file 252 (e.g., as updated model file 254) to include the bone indices associated with each of the extracted subset of bones and updated bone weights for the subset of bones. As illustrated in FIG. 3, updated model file 254 can include updated bone index data 334 and updated bone weight data 336. Updated bone index data 334 can include an indication of the bone indices for each of the extracted subset of bones. In accordance with the previous example, the bone indices for the extracted subset of bones can be [2, 3, 4, 5]. Updated bone weight data 336 can include the normalized values for the bone weights associated with each of the extracted subset of bones. In accordance with the previous example, the updated bone weight data 336 can indicate that the weights associated with the extracted subset of bones is [0.25, 0.25, 0.25, 0.25].

Coordinate generator 316 can convert data associated with the bones that are not included in the extracted subset of bones to other types of rendering data, in some embodiments. In some embodiments, the other types of rendering data can include one or more texturing coordinates 338. Coordinate generator 316 can convert the data associated with the remaining bones of the set of bones by associating a bone index of a respective bone with a first value of the texturing coordinate 338 and the weight of the bone index with a second value of the texturing coordinate 338. According to the previous illustrative example, bones having indices of [1, 0, 6, 7] may not be included in the subset of bones extracted from the set of bones by bone extractor 312. The corresponding weights associated with each of the remaining bones can be [0.15, 0.1, 0.05, and 0], respectively. Coordinate generator 316 can convert the bone data to the texturing coordinates by associating the bone index of each remaining bone with a first value of the texturing coordinate 338 and the corresponding bone weight with the second value of the texturing coordinate 338. The texturing coordinates 338 obtained based on each of the remaining bones can be [1.15, 0.1, 6.05, and 7.0], respectively. Rendering data component 224 can include the texturing coordinates 338 obtained by coordinate generator 316. In some embodiments, rendering data component 224 can include the texturing coordinates with the other rendering data 328.

Rendering data component 224 can provide the updated model file 254 associated with the 3D object (e.g., the virtual avatar) to rendering engine 152, in some embodiments. Referring back to FIG. 2, model engine 142 can be connected to rendering engine 152 via one or more data channels 228. A data channel 228 refers to a data path used to transfer particular types of information from one system to another. Data channels 228 can be physical data channels and/or software (e.g., virtual) data channels, in some embodiments. One or more data channels (e.g., data channel 228A, 228B, 228N, etc.) can connect model engine 142 and/or rendering engine 152, in some embodiments. It should be noted that any number of data channels can connect model engine 142 and/or rendering engine 152, which can include more or fewer channels than depicted in FIG. 2.

In some embodiments, each data channel 228 can be associated with a particular type of rendering data used by rendering engine 152 to render the 3D object. In an illustrative example, data channel 228A can be associated with skinning data for rendering the 3D object. The skinning data can include data that indicates vertices of a mesh for the 3D object and a set (or subset) of bones assigned to each respective vertex, in some embodiments. Data channel 228B-228N can be associated with other types of data for rendering the 3D object. For example, data channel 228B can be associated with texturing coordinates for rendering the 3D object.

First data channel module 218 can transmit a portion of updated model file 254 to rendering engine 152 via a first data channel associated with skinning data for rendering the 3D object (e.g., data channel 228A). For example, first data channel module 318 can transmit mesh vertex data 322, updated bone index data 334, and/or updated bone weight data 336 to rendering engine 152 via data channel 228A. Second data channel model 218 can transmit a portion of updated model file 254 to rendering engine 152 via a second data channel associated with other types of data for rendering the 3D object (e.g., data channel 228B). For example, second data channel model 320 can transmit texturing coordinates 338 (e.g., of other rendering data 328) to rendering engine 152 via second data channel 228B.

Rendering engine 152 can render the 3D object (e.g., the virtual avatar) based on data received via one or more data channels 228 from model engine 142. As described above, rendering engine 152 can receive skinning data associated with rendering the 3D object via data channel 228A and other data associated with rendering the 3D object via data channel 228B. The other data received via data channel 228B can include one or more texturing coordinates 340. The data received via data channels 228 (e.g., data channel 228A, data channel 228B, etc.) can correspond to data of updated model file 254, in some embodiments.

As illustrated in FIG. 2, rendering engine 152 can include a rendering data converter 232 and/or a rendering component 234. In some embodiments, rendering engine 152 may be enabled to render 3D objects having a number of bones per vertex that exceeds the threshold number of bones. For example, the threshold number of bones can be four bones per vertex and rendering engine 152 can be configured to render a 3D object having eight, 16, 32, etc. bones per vertex. As described above, updated bone index data 334 and/or updated bone weight data 336 can indicate a first subset of bones assigned to a vertex (e.g., including a number of bones that meets the threshold number of bones) and texturing coordinates 338 can indicate a second subset of bones assigned to the vertex (e.g., including additional bones assigned to the vertex that exceeds the threshold number of bones). Rendering data converter 232 can convert the updated bone index data 334, the updated bone weight data 336, and/or the texturing coordinates to updated skinning data that indicates the first subset of bones and the second subset of bones, and the weights associated with the first sub set of bones and the second subset bones, as described below.

Rendering data converter 232 can determine the first subset of bones of the bone structure assigned to the vertex based on the data received by data channel 228A, as described above. As indicated above, the data received by data channel 228A can correspond to the updated bone index data 334 and/or the updated bone weight data 336 of updated model file 254. Rendering data converter 232 can determine each of the first set of bones based on the bone indices indicated by updated bone index data 334, in some embodiments. In accordance with the previously provided examples, rendering data converter 232 can determine that the first set of bones (e.g., the bones extracted by bone extractor 312) have bone indices of [2, 3, 4, 5]. Rendering data converter 232 can determine the weight for each of the first set of bones based on the bone weights indicated by updated bone weight data 336. In accordance with the previously provided examples, rendering data converter 232 can determine that the first set of bones have bone weights of [0.25, 0.25, 0.25, 0.25].

As indicated above, data received by data channel 228B can include texturing coordinates 340 that were generated based on data for bones assigned to the vertex that exceed the threshold number of bones. A first value of a texturing coordinate can indicate a bone index for a bone and a second value of the texturing coordinate can indicate a bone weight for the bone. Rendering data converter 232 can determine the bone indices for the second subset of bones (e.g., bones that exceed the threshold number of bones assigned to the vertex) based on the first values of the texturing coordinates received via data channel 228B. In accordance with the previous example, the texturing coordinates 340 received via data channel 228B are [1.15, 0.1, 6.05, 7.0]. Rendering data converter 232 can accordingly determine that the bone indices associated with such bones are [1, 0, 6, 7]. Rendering data converter 232 can similarly determine that the weights of the bones are [0.15, 0.1, 0.05, 0].

In some embodiments, rendering data converter 232 can determine updated weight values (e.g., non-normalized weight values) for the first sub set of bones based on a total number of bones of the first subset of bones and the second subset of bones. In an illustrative example, the total number of the first subset of bones and the second subset of bones can be eight bones, as provided above. The weights associated with the first subset of bones is [0.25, 0.25, 0.25, 0.25]. Rendering data converter 232 can determine, based on the weights associated with the first subset of bones and the total number of the first subset of bones and the second subset of bones that the updated weight values (e.g., the non-normalized weight values) for the first subset of bones is [0.2, 0.2, 0.2, 0.2]. Accordingly, rendering data converter 232 can determine that the weights for each of the first subset of bones and the second subset of bones are [0.2, 0.2, 0.2, 0.15, 0.1, 0.05, 0], which correspond to bone weight data 326 of model file 252.

Rendering data converter 232 can provide the bone indices for each of the first subset of bones and the second subset of bones and the determined updated weight values to rendering component 234. Rendering component 234 can render the object based on the data received from rendering data converter 232. Accordingly, rendering component 234 can render the object having a number of bones per vertex that exceeds the threshold number of bones.

In some embodiments, rendering engine 152 may be enabled to render 3D objects having a number of bones per vertex that meets the threshold number of bones. In such embodiments, rendering component 234 can render the 3D object (e.g., the virtual avatar) based on the data of updated model file 254. For example, rendering component 234 can render the 3D object based on the updated bone index data 334 and/or the updated bone weight data 336, which indicates that the number of bones assigned to the vertex satisfies the threshold number of bones. In such embodiments, rendering data converter 232 may not convert the texturing coordinates 340 to skinning data, as described above. Rendering component 234 can accordingly ignore or disregard the texturing coordinates 340.

Rendering engine 152 can render the 3D object (e.g., the virtual object) as rendered object 112. In some embodiments, rendering engine 152 can provide rendered object 112 to platform 120. Platform 120 can provide rendered object 112 to client device 102 for presentation to a user associated with client device 102 via a UI of client device 102. In other or similar embodiments, rendering engine 152 can store rendered object 112 at memory 250. Platform 120 can obtain rendered object 112 from memory 250 and can provide rendered object 112 to client device 102, as described above.

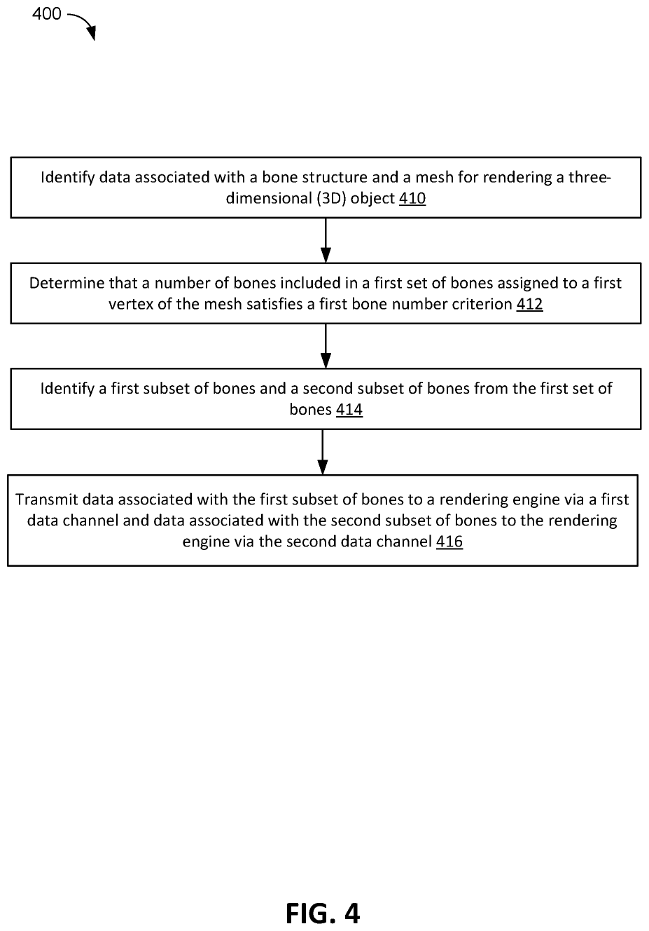

FIG. 4 illustrates a flow diagram for an example method 400 for providing data for rending a three-dimensional (3D) object to a rendering engine, in accordance with some aspects of the present disclosure. Method 400 may be performed by processing logic that may include hardware (circuitry, dedicated logic, etc.), software (e.g., instructions run on a processing device), or a combination thereof. In one implementation, some or all the operations of method 400 may be performed by one or more components of system 100 of FIG. 1 and/or one or more components of FIG. 2. In some embodiments, one or more operations of method 400 may be performed by rendering data component 224 of model engine 142.

At block 410, processing logic identifies data associated with a bone structure and a mesh for rendering a three-dimensional (3D) object. The identified data can include, for each vertex of the mesh, an indication of a set of bones of the bone structure assigned to the vertex and a weight for each bone of the assigned set of bones. The 3D object can include a virtual avatar. At block 412, processing logic determines that a number of bones included in a first set of bones assigned to a first vertex of the mesh satisfies a first bone number criterion. The first vertex can satisfy the first bone number criterion if the number of bones assigned to the first vertex exceeds a threshold number of bones that corresponds to a standard number of bones assigned to vertices of meshes for 3D objects according to a rendering protocol associated with one or more rendering engines. At block 414, processing logic identifies a first subset of bones and a second subset of bones from the first set of bones. The weight of each of the first subset of bones satisfies a weight condition. A respective weight of the first set of bones satisfies the weight condition if the respective weight is larger than the weight for at least a portion of other bones of the first set of bones. A number of bones of the first subset of bones satisfies a second bone number criterion. The number of bones of the first subset of bones satisfies the second bone number criterion if the number of bones meets the threshold number of bones.

In some embodiments, processing logic can update the weight associated with each of the first subset of bones to a normalized value in view of a number of bones included in the first subset of bones. The updated weights associated with the first subset of bones is included in the data transmitted via the first data channel. A sum of the weights associated with the first subset of bones has a value of less than one. A sum of the updated weights associated with the first subset of bones has an approximate value of one.

At block 416, processing logic transmits data associated with the first subset of bones to a rendering engine via a first data channel and data associated with the second subset of bones to the rendering engine via the second data channel. The first data channel is associated with skinning data for rendering 3D objects. The second data channel is associated with one or more other types of data for rendering the 3D objects. The data transmitted to the rendering engine via the first data channel includes at least one of an indication of the first vertex of the mesh, a bone index for each of the first subset of bones, or the weight associated with each of the first subset of bones. The data transmitted to the rendering engine via the second data channel includes at least one of an indication of the first vertex of the mesh, the bone index for each of the second subset of bones, or the weight associated with each of the second subset of bones. In some embodiments, the data transmitted to the rendering engine via the first data channel and the data transmitted to the rendering engine via the second data channel is included in a model file associated with the 3D object.

In some embodiments, the second data channel is associated with texturing data for rendering 3D objects. In such embodiments, processing logic can convert, for each respective bone of the second subset of bones, a bone index associated with the respective bone and the weight of the respective bone to one or more texturing coordinates associated with the 3D object. The one or more texturing coordinates comprise at least one of a two-dimensional (2D) texture coordinate, a three-dimensional (3D) texture coordinate, or a four-dimensional (4D) texture coordinate. Processing logic can convert the bone index associated with the respective bone and the weight of the respective bone into the one or more texturing coordinates by extracting the bone index from the identified data associated with the bone structure and the mesh for the 3D object. Processing logic can associate the bone index with a first value of the one or more texturing coordinates and can associate the weight of the respective bone with a second value of the one or more texturing coordinates. The one or more texturing coordinates are included in the data transmitted via the second data channel.

In some embodiments, processing logic can determine that a number of bones included in a second set of bones assigned to a second vertex satisfies the threshold number of bones. In such embodiments, processing logic can transmit a portion of the identified data associated with the second set of bones to the rendering engine via the first data channel.

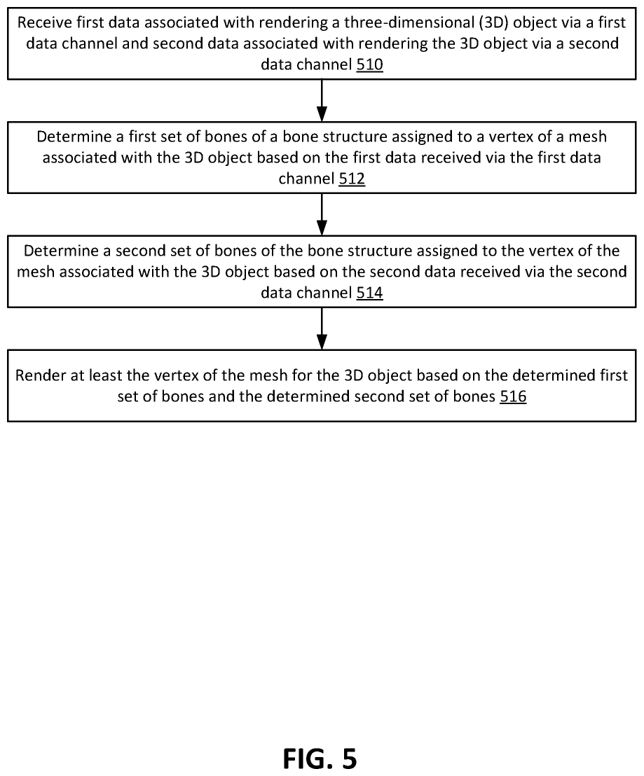

FIG. 5 illustrates a flow diagram for an example method 500 rendering a 3D object, in accordance with some aspects of the present disclosure. Method 500 may be performed by processing logic that may include hardware (circuitry, dedicated logic, etc.), software (e.g., instructions run on a processing device), or a combination thereof. In one implementation, some or all the operations of method 500 may be performed by one or more components of system 100 of FIG. 1 and/or one or more components of FIG. 2. In some embodiments, one or more operations of method 500 may be performed by rendering engine 152.

At block 510, processing logic receives first data associated with rendering a three-dimensional (3D) object via a first data channel and second data associated with rendering the 3D object via a second data channel. The first data and second data can be received by a rendering engine. The rendering engine can be associated with a content sharing platform. The 3D object can include a virtual avatar associated with a user of the content sharing platform. The first data channel is associated with skinning data for rendering 3D objects. The second data channel is associated with one or more other types of data for rendering 3D objects. In some embodiments, the first data includes at least one of an indication of the vertex of the mesh, a bone index for each of the first set of bones, or a weight associated with each of the first set of bones. In some embodiments, the second data includes at least one of an indication of the vertex of the mesh, the bone index for each of the second set of bones, or a weight associated with each of the second set of bones. The first data received via the first data channel and the second data received via the second data channel can be included in a model file associated with the 3D object.

At block 512, processing logic determines a first set of bones assigned to a vertex of a mesh associated with the 3D object based on the first data received via the first data channel. A number of the first set of bones satisfies a threshold number of bones. The threshold number of bones corresponds to a standard number of bones assigned to vertices of meshes for 3D objects according to a rendering protocol associated with one or more rendering engines not including the rendering engine.

At block 514, processing logic determines a second set of bones of the bone structure assigned to the vertex of the mesh associated with the 3D object based on the second data received via the second data channel. The second data channel can be associated with texturing data for rendering 3D objects and the second data received via the second data channel comprises one or more texturing coordinates, in some embodiments. In such embodiments, processing logic can determine the second set of bones based on the second data by extracting, from the one or more texturing coordinates, an indication of a bone index of a bone of the second set of bones and extracting, from the one or more texturing coordinates, an indication of a weight associated with the bone.

At block 516, processing logic renders at least the vertex of the mesh for the 3D object based on the determined first set of bones and the determined second set of bones. In some embodiments, processing logic can determine, based on the first data and the second data, a weight associated with each of the first set of bones and each of the second set of bones. Processing logic can update the weight associated with each of the first set of bones and each of the second set of bones based on a total number of bones assigned to the vertex. The total number of bones assigned to the vertex includes a summation of a number of the first set of bones and a number of the second set of bones. The vertex of the mesh for the 3D object is rendered based on the updated weight associated with each of the first set of bones and each of the second set of bones.

In some embodiments, processing logic can provide at least the rendered vertex of the mesh for the 3D object for presentation via a graphical user interface of one or more client devices connected to the content sharing platform via a network. At least one of the one or more client devices are associated with the user of the content sharing platform. The at least the rendered vertex of the mesh for the 3D object may be provided in response to one or more requests from the one or more client devices.

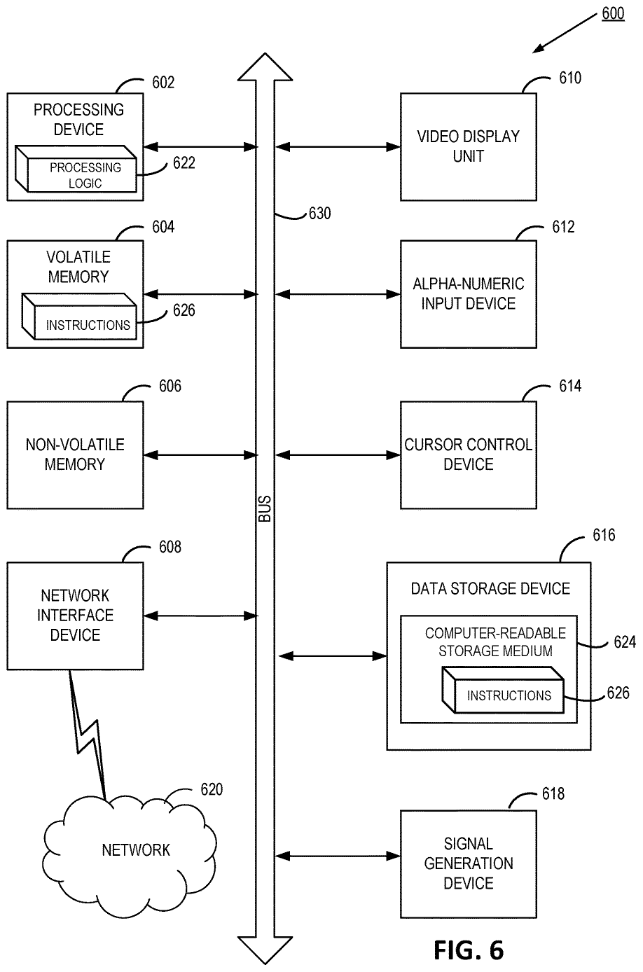

FIG. 6 is a block diagram illustrating an exemplary computer system, in accordance with implementations of the present disclosure. The computer system 600 can be the server machine 130-140 or client devices 102A-N in FIG. 1. The machine can operate in the capacity of a server or an endpoint machine in endpoint-server network environment, or as a peer machine in a peer-to-peer (or distributed) network environment. The machine can be a television, a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 600 includes a processing device (processor) 602, a main memory 604 (e.g., read-only memory (ROM), flash memory, dynamic random access memory (DRAM) such as synchronous DRAM (SDRAM), double data rate (DDR SDRAM), or DRAM (RDRAM), etc.), a static memory 606 (e.g., flash memory, static random access memory (SRAM), etc.), and a data storage device 618, which communicate with each other via a bus 640.

Processor (processing device) 602 represents one or more general-purpose processing devices such as a microprocessor, central processing unit, or the like. More particularly, the processor 602 can be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processor 602 can also be one or more special-purpose processing devices such as an application specific integrated circuit (ASIC), a field programmable gate array (FPGA), a digital signal processor (DSP), network processor, or the like. The processor 602 is configured to execute instructions 605 (e.g., for predicting channel lineup viewership) for performing the operations discussed herein.

The computer system 600 can further include a network interface device 608. The computer system 600 also can include a video display unit 610 (e.g., a liquid crystal display (LCD) or a cathode ray tube (CRT)), an input device 612 (e.g., a keyboard, and alphanumeric keyboard, a motion sensing input device, touch screen), a cursor control device 614 (e.g., a mouse), and a signal generation device 620 (e.g., a speaker).

The data storage device 618 can include a non-transitory machine-readable storage medium 624 (also computer-readable storage medium) on which is stored one or more sets of instructions 605 (e.g., for rendering 3D objects) embodying any one or more of the methodologies or functions described herein. The instructions can also reside, completely or at least partially, within the main memory 604 and/or within the processor 602 during execution thereof by the computer system 600, the main memory 604 and the processor 602 also constituting machine-readable storage media. The instructions can further be transmitted or received over a network 630 via the network interface device 608.

In one implementation, the instructions 605 include instructions for predicting channel lineup viewership. While the computer-readable storage medium 624 (machine-readable storage medium) is shown in an exemplary implementation to be a single medium, the terms “computer-readable storage medium” and “machine-readable storage medium” should be taken to include a single medium or multiple media (e.g., a centralized or distributed database, and/or associated caches and servers) that store the one or more sets of instructions. The terms “computer-readable storage medium” and “machine-readable storage medium” shall also be taken to include any medium that is capable of storing, encoding or carrying a set of instructions for execution by the machine and that cause the machine to perform any one or more of the methodologies of the present disclosure. The terms “computer-readable storage medium” and “machine-readable storage medium” shall accordingly be taken to include, but not be limited to, solid-state memories, optical media, and magnetic media.

Reference throughout this specification to “one implementation,” or “an implementation,” means that a particular feature, structure, or characteristic described in connection with the implementation is included in at least one implementation. Thus, the appearances of the phrase “in one implementation,” or “in an implementation,” in various places throughout this specification can, but are not necessarily, referring to the same implementation, depending on the circumstances. Furthermore, the particular features, structures, or characteristics may be combined in any suitable manner in one or more implementations.

To the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

As used in this application, the terms “component,” “module,” “system,” or the like are generally intended to refer to a computer-related entity, either hardware (e.g., a circuit), software, a combination of hardware and software, or an entity related to an operational machine with one or more specific functionalities. For example, a component may be, but is not limited to being, a process running on a processor (e.g., digital signal processor), a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers. Further, a “device” can come in the form of specially designed hardware; generalized hardware made specialized by the execution of software thereon that enables hardware to perform specific functions (e.g., generating interest points and/or descriptors); software on a computer readable medium; or a combination thereof.

The aforementioned systems, circuits, modules, and so on have been described with respect to interact between several components and/or blocks. It can be appreciated that such systems, circuits, components, blocks, and so forth can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but known by those of skill in the art.

Moreover, the words “example” or “exemplary” are used herein to mean serving as an example, instance, or illustration. Any aspect or design described herein as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Finally, implementations described herein include collection of data describing a user and/or activities of a user. In one implementation, such data is only collected upon the user providing consent to the collection of this data. In some implementations, a user is prompted to explicitly allow data collection. Further, the user may opt-in or opt-out of participating in such data collection activities. In one implementation, the collect data is anonymized prior to performing any analysis to obtain any statistical patterns so that the identity of the user cannot be determined from the collected data.

What is claimed is:

1. A method comprising:
identifying, by a processing device, data associated with a bone structure and a mesh for rendering a three-dimensional (3D) object, wherein the identified data comprises, for each vertex of the mesh, an indication of a set of bones of the bone structure assigned to the vertex and a weight for each bone of the assigned set of bones;
determining, by the processing device, that a number of bones included in a first set of bones assigned to a first vertex of the mesh satisfies a first bone number criterion;
identifying, by the processing device and from the first set of bones, a first subset of bones and a second subset of bones, wherein the weight of each of the first subset of bones satisfies a weight condition, and wherein a number of bones of the first subset of bones satisfies a second bone number criterion; and
transmitting, to a rendering engine, data associated with the first subset of bones as skinning data for rendering 3D objects and the second subset of bones as one or more other types of data for rendering the 3D objects.

2. The method of claim 1, wherein the one or more other types of data for rendering the 3D objects comprises texturing data, and wherein the method further comprises:
converting, for each respective bone of the second subset of bones, a bone index associated with the respective bone and the weight of the respective bone to one or more texturing coordinates associated with the 3D object, wherein the one or more texturing coordinates are included in texturing data transmitted to the rendering engine.

3. The method of claim 2, wherein converting the bone index associated with the respective bone and the weight of the respective bone into the one or more texturing coordinates comprises:
extracting the bone index from the identified data associated with the bone structure and the mesh for the 3D object;
associating the bone index with a first value of the one or more texturing coordinates; and
associating the weight of the respective bone with a second value of the one or more texturing coordinates.

4. The method of claim 2, wherein the one or more texturing coordinates comprise at least one of a two-dimensional (2D) texture coordinate, a three-dimensional (3D) texture coordinate, or a four-dimensional (4D) texture coordinate.

5. The method of claim 1, further comprising:
updating the weight associated with each of the first subset of bones to a normalized value based on the number of bones of the first subset of bones.

6. The method of claim 5, wherein a sum of the weights associated with the first subset of bones has a value of less than one, and wherein a sum of the updated weights associated with the first subset of bones has an approximate value of one.

7. The method of claim 1, wherein a respective weight of the first set of bones satisfies the weight condition if the respective weight is larger than the weight for at least a portion of other bones of the first set of bones.

8. The method of claim 1, further comprising:
determining that a number of bones included in a second set of bones assigned to a second vertex satisfies the second bone number criterion; and
transmitting a portion of the identified data associated with the second set of bones to the rendering engine as the skinning data for rendering the 3D objects.

9. The method of claim 1, wherein at least one of the first bone number criterion or the second bone number criterion comprises a threshold number of bones that corresponds to a standard number of bones assigned to vertices of meshes for 3D objects according to a rendering protocol associated with one or more rendering engines.

10. The method of claim 1, wherein the 3D object comprises a virtual avatar.

11. The method of claim 1, wherein the data transmitted to the rendering engine as skinning data for rendering 3D objects is transmitted via a first data channel and comprises at least one of an indication of the first vertex of the mesh, a bone index for each of the first subset of bones, or the weight associated with each of the first subset of bones, and wherein the data transmitted to the rendering engine as the one or more other types of data for rendering the 3D objects is transmitted via a second data channel and comprises at least one of an indication of the first vertex of the mesh, the bone index for each of the second subset of bones, or the weight associated with each of the second subset of bones.

12. The method of claim 11, wherein the data transmitted to the rendering engine via the first data channel and the data transmitted to the rendering engine via the second data channel are included in a model file associated with the 3D object.

13. A system comprising:
a memory; and
a processor communicatively coupled to the memory, the processor to perform operations comprising:
identifying data associated with a bone structure and a mesh for rendering a three-dimensional (3D) object, wherein the identified data comprises, for each vertex of the mesh, an indication of a set of bones of the bone structure assigned to the vertex and a weight for each bone of the assigned set of bones;
determining that a number of bones included in a first set of bones assigned to a first vertex of the mesh satisfies a first bone number criterion;
identifying, from the first set of bones, a first subset of bones and a second subset of bones, wherein the weight of each of the first subset of bones satisfies a weight condition, and wherein a number of bones of the first subset of bones satisfies a second bone number criterion; and
transmitting, to a rendering engine, data associated with the first subset of bones as skinning data for rendering 3D objects and the second subset of bones as one or more other types of data for rendering the 3D objects.

14. A system comprising:
a memory; and
a processor communicatively coupled to the memory, the processor to perform operations comprising:
receiving, using a rendering engine, first data associated with rendering a three-dimensional (3D) object via a first data channel and second data associated with rendering the 3D object via a second data channel, wherein the first data channel is associated with skinning data for rendering 3D objects and the second data channel is associated with one or more other types of data for rendering 3D objects;
determining, using the rendering engine and based on the first data received via the first data channel, a first set of bones of a bone structure for the 3D object, the first set of bones assigned to a vertex of a mesh associated with the 3D object;
determining, using the rendering engine and based on the second data received via the second data channel, a second set of bones of the bone structure, the second set of bones assigned to the vertex of the mesh associated with the 3D object; and
rendering, using the rendering engine, at least the vertex of the mesh for the 3D object based on the determined first set of bones and the determined second set of bones.

15. The system of claim 14, wherein the second data channel is associated with texturing data for rendering 3D objects and the second data received via the second data channel comprises one or more texturing coordinates, and wherein determining the second set of bones based on the second data comprises:
extracting, from the one or more texturing coordinates, an indication of a bone index of a bone of the second set of bones; and
extracting, from the one or more texturing coordinates, an indication of a weight associated with the bone.

16. The system of claim 14, wherein the operations further comprise:
determining, based on the first data and the second data, a weight associated with each of the first set of bones and each of the second set of bones; and
updating the weight associated with each of the first set of bones and each of the second set of bones based on a total number of bones assigned to the vertex, wherein the total number of bones assigned to the vertex comprises a summation of a number of the first set of bones and a number of the second set of bones, and
wherein the vertex of the mesh for the 3D object is rendered based on the updated weight associated with each of the first set of bones and each of the second set of bones.

17. The system of claim 14, wherein a number of the first set of bones satisfies a bone number criterion comprising a threshold number of bones corresponding to a standard number of bones assigned to vertices of meshes for 3D objects according to a rendering protocol associated with one or more rendering engines not including the rendering engine.

18. The system of claim 14, wherein the first data comprises at least one of an indication of the vertex of the mesh, a bone index for each of the first set of bones, or a weight associated with each of the first set of bones, and wherein the second data comprises at least one of an indication of the vertex of the mesh, the bone index for each of the second set of bones, or a weight associated with each of the second set of bones.

19. The system of claim 14, wherein the first data received via the first data channel and the second data received via the second data channel are included in a model file associated with the 3D object.

20. The system of claim 14, wherein the rendering engine is associated with a content sharing platform and the 3D object comprises a virtual avatar associated with a user of the content sharing platform, and wherein the operations further comprise:
providing at least the rendered vertex of the mesh for the 3D object for presentation via a graphical user interface of one or more client devices connected to the content sharing platform via a network, wherein at least one of the one or more client devices is associated with the user of the content sharing platform, and wherein the at least the rendered vertex of the mesh for the 3D object is provided in response to one or more requests from the one or more client devices.

21. (canceled)

22. (canceled)

23. (canceled)

24. (canceled)
